(19) United States
(12) Patent Application Publication
(10) Pub. No.: US 2018/0124527 A1
(43) Pub. Date: May 3, 2018

(54) HEARING ASSISTANCE METHOD UTILIZING A BROADCAST AUDIO STREAM

(71) Applicants: Amre EL-HOIYDI, Neuchâtel (CH); Stephan GEHRING, Uerikon (CH); Marc SECALL, Constantine (CH); Thomas VON DACH, Cressier (CH)

(72) Inventors: Amre EL-HOIYDI, Neuchâtel (CH); Stephan GEHRING, Uerikon (CH); Marc SECALL, Constantine (CH); Thomas VON DACH, Cressier (CH)

(73) Assignee: SONOVA AG, Stäfa (CH)

(21) Appl. No.: 15/522,936

(22) PCT Filed: Nov. 3, 2014
(86) PCT No.: PCT/EP2014/073574

§ 371 Date: Apr. 28, 2017

(51) Int. Cl. H04R 25/00; H04R 27/02; H04H 20/53; G06Q 10/02; H04L 29/06

(52) U.S. Cl. CPC H04R 25/554; H04R 25/552; H04R 27/02; H04H 20/53; H04W 4/008; H04L 63/0428; H04R 2225/55; H04R 2227/003; H04W 76/02; G06Q 10/02

(57) ABSTRACT

A method of providing hearing assistance to a user of a hearing system (10, 11, 15) by utilizing an event-related audio broadcast stream (74), the method having the steps of: registering, by the user, for an event; providing, in response to said registering, a personal device (60) of the user with a stream access code required to connect to the broadcast audio stream; establishing a wireless link (72) between the hearing system and the personal device and transmitting the stream access code from the personal device to the hearing system; and connecting, by the hearing system, to the broadcast audio stream.

### BACKGROUND OF THE INVENTION

### Field of the Invention

The invention relates to a method of providing hearing assistance to a user of a hearing system by accessing a broadcast audio stream.

### Description of Related Art

Public locations, like churches, cinemas, theatres, or concert halls, may offer broadcast audio streams which may be wirelessly received by hearing devices like hearing aids, hearing prosthesis devices or wireless headphones. Such broadcast audio stream is characterized by a “stream access code” which may include some stream identifier and, optionally, encryption keys for encrypting the audio stream. Accordingly, an audio device needs to know the stream access code of a certain broadcast audio stream in order to be able to—and to be allowed to—connect to the audio stream. In some cases, such as in a church, the stream access code may be known in advance; in such cases, the stream access code could be stored already in advance in the hearing device at production time. In other cases, however, such as in a cinema, a theatre, or a concert hall, the stream access code may be specific to a given broadcast audio stream and will not be known in advance. In particular, the stream access code may be used to allow only certain authorized hearing devices to connect to the audio stream.

In general, there are various known concepts of access control, for example, in the field of television broadcast (“pay-per-view”). Further, a common concept to control access to events is to provide tickets with optical codes, such as QR codes or bar codes which may be read by appropriate electronic devices. Also mobile phones may be able to read such QR codes. It is also known to store an encryption key in such QR code.

In the field of hearing devices it is known to synchronize audio receiver devices into a local area acoustic network either via pressing a button on an audio transmission device when it is in close proximity of the audio receiver device or via passing by a device which is located, for example, at the entrance of a room where the network is to be established, such as a class room, and which permanently broadcasts the information required to join the network, such as the network ID.

European Patent Application EP 2 755 402 A1 and corresponding U.S. Patent Application Publication 2014/0193007 A1 relate to a method of providing a stream access code to a hearing aid based on proximity in most direction of the hearing aid with regard to a reference point which may be a location of an external device broadcasting an audio stream and including sensors for detecting proximity motion direction of the hearing aid. Alternatively, a separate sensing device may be provided detecting proximity in motion direction of the hearing aid. A smartphone may act as a gateway device for the hearing aid, the smartphone receiving the broadcast audio stream and relaying the audio stream to the hearing aid.

European Patent Application EP 2 755 403 A1 and corresponding U.S. Patent Application Publication 2014/0192988 A1 relate to a method of providing a stream access code to a hearing aid, wherein an audio stream is transmitted from a master Bluetooth device to a slave Bluetooth receiver device, such as a hearing aid, and wherein other hearing aids may receive stream access information by eavesdropping of the audio stream transmitted from the master device to the slave device; a separate advertising channel is used to provide for the stream access information.

International Patent Application Publication WO 2013/130679 A1 and corresponding U.S. Pat. Nos. 8,495,236 B1 and 9,590,837 B2 relate to a method of allowing a user of a smartphone or similar device to select a specific audio stream he wants to listen to on his device via an application, similar to an “internet radio” application.

U.S. Pat. No. 8,340,331 B2 relates to a method of providing a stream access code to a user of an audio receiver device via a receiver configuration unit placed at the entrance of a room, such as a movie theatre.

U.S. Pat. No. 7,174,017 B2 relates to a method of providing a stream access code to the user of a hearing device via a dedicated portable device containing a decryption key to be used by the hearing device. The dedicated portable device may read the key from a computer system when the user approaches the computer system.

U.S. Patent Application Publication 2005/023912 A1 relates to a method wherein an audio headset is remotely configured for operation in a wireless network by receiving an audio signal encoded with configuration data.

### SUMMARY OF THE INVENTION

It is an object of the invention to provide for a method of providing a stream access code to the user of a hearing system which is particularly convenient to the user.

According to the invention, this object is achieved by a method as described herein.

A first feature of the invention is beneficial in that, by providing, in response to registering by the user for an event, a personal device of the user, such as a smartphone, with the required stream access code which then is wirelessly transmitted from the personal device to the hearing system, the hearing system can be provided with the stream access code in a particularly simple and convenient manner. In particular, no specific user interaction is required to connect the hearing system to the broadcast audio system, since the personal device can take all actions required to configure the hearing system to receive the desired broadcast audio stream.

Another feature is particularly beneficial in case that there is no registering to an event by the user; also in this case the user is not required to take specific action for connecting the hearing system to the broadcast audio stream, since the personal device, after scanning and decoding of the optical code pattern, automatically provides the stream access code to the hearing system in order to configure the hearing system for receiving the broadcast audio stream.

As used herein, the term “registering to an event” designates all kind of actions required to obtain admission to the event, such as purchasing a ticket; in particular, it does not require that personal data is supplied to the event provider. For example, the user may register to an event by anonymously purchasing a ticket for the event.

As used herein, “BLUETOOTH®” includes both the BLUETOOTH® Classic variant and the BLUETOOTH® Low Energy variant of the Bluetooth standard.

Hereinafter, examples of the invention will be illustrated by reference to the accompanying drawings.

### BRIEF DESCRIPTION OF THE DRAWINGS

FIG. 1 is a schematic block diagram of an example of devices involved in a method according to the invention;

FIG. 2 is an illustration of a first step of a method according to the invention, wherein a personal device of a hearing system user is provided with a stream access code;

FIG. 3 is an illustration of a second step of a method according to the invention, wherein the personal devices provides the stream access code to the hearing system;

FIG. 4 is an illustration of a third step of a method according to the invention, wherein the hearing system receives an audio broadcast stream;

FIG. 5 is an illustration of a variant of a first step of a method according to the invention; and

FIG. 6 is an illustration of a variant of a second step of a method according to the invention.

### DETAILED DESCRIPTION OF THE INVENTION

FIG. 1 is a schematic representation of an example of a hearing system to be used with the invention, comprising a first hearing device 10 worn at one ear of a user and a second hearing device 11 worn at the other ear of the user. The hearing devices 10, 11 may exchange between each other via a wired or wireless link 70 in order to implement a binaural hearing assistance system. The hearing devices 10, 11 are also adapted to receive a wireless external audio stream 74 from an external audio source 62. Further, the hearing devices 10, 11 are able to communicate with a personal device 60 of the user via a wireless link 72.

The personal device may be a handheld or body-worn personal communication device, such as a mobile phone or a tablet computer. According to another example, the personal device may be personal computer.

The hearing assistance devices 10, 11 may be hearing aids, such as BTE (behind the ear), ITE (in the ear) or CIC (completely in the channel) hearing aids. However, the hearing assistance devices, for example, also could be an auditory prosthesis, such as a cochlear implant device. According to another example, the hearing assistance devices could form a headset or headphones or ear buds for a normal hearing person.

According to the example of FIG. 1, the hearing assistance devices 10, 11 are electro-acoustic hearing aids comprising a microphone arrangement 12 for capturing audio signals from ambient sound, an audio signal processing unit 14 for processing the captured audio signals and an electro-acoustic output transducer (loudspeaker) 16 for stimulation the user's hearing according to the processed audio signals (these elements are shown in FIG. 1 only for the hearing aid 10).

In the example of FIG. 1, the hearing aids 10, 11 comprise a first wireless interface 18 including an antenna 22 and a transceiver 24 and a second wireless interface 20 including an antenna 26 and a transceiver 28.

The first interface 18 is provided for enabling wireless data exchange between the first hearing aid 10 and the second hearing aid 11 via the wireless link 70 which, according to one example, may be an inductive link which may operate, for example, in a frequency range of 6.765 MHz to 13.567 MHz, such as at 10.6 MHz. For example, the first interface 18 may be designed to form part of a hearing instrument body area network (HIBAN). However, rather than being implemented as an inductive link, the wireless link 70 may be a far-field link, such as a proprietary digitally modulated link operating in the 2.4 GHz ISM band, or a standard link, such as Bluetooth.

The link 70 serves to realize a binaural hearing assistance system, allowing the hearing aids 10, 11 to exchange audio signals and/or control data and status data, such as the present settings of the hearing aids 10, 11.

The second interface 20 may be provided for data exchange via the wireless link 72 with the personal device 60 and for receiving a broadcast audio data stream via the link 74 from the external audio source 62. For example, the second interface 20 may be adapted to operate in a frequency range of 0.38 GHz to 5.825 GHz, preferably at frequencies around 2.4 GHz in the ISM band. For example, the second interface 20 may be a Bluetooth interface, a WLAN (WiFi) interface or a GSM interface. Preferably, it a Bluetooth interface.

The broadcast audio stream may be a mono or stereo audio stream, whereby left and right channels of the audio signal may be provided to the left ear and right ear hearing device jointly or individually.

The hearing aids 10, 11 also comprise a controller 38 for controlling operation of the hearing aids 10, 11, with the controller 38 acting on the signal processing unit 14 and the transceivers 24 and 28.

The personal device 60 likewise comprises an interface 20 for transmitting data/signals of the external data stream via the external data link 72 to the hearing aids 10, 11.

The binaural link 70 may be a wireless link, as shown in FIG. 1, or it may be a wired link, for example, when the hearing system is a headphone or when the hearing system is composed of two earpieces connected with a flexible cable.

In case that the binaural link 70 is a wireless link, the protocol/interface for the binaural link 70 and the external data link 72 may be the same (in this case the interface 20 used for the binaural link 70 also could be used for data reception from the external device 60 via the link 72) or it may be different (requiring two separate interfaces 18, 20 for the links 70 and 72, respectively); the protocol/interface may be proprietary or it may be standard-based (such as Bluetooth, WLAN or GSM).

While the interface 20 typically may be used both for receiving the broadcast audio stream 74 and for communicating with the personal device 60, there may be cases in which a separate interface is provided for each of these two functions.

Typically, the hearing devices 10, 11 need to know the stream access code in order to be able to listen to the broadcast audio stream 74 from an audio source 62.

For example, the audio stream 74 may be related to a certain event, such as the presentation of a movie in a cinema, a concert in a concert hall or a stage performance in a theatre. In such cases, the personal device 60 of the user of the hearing devices 10, 11 may be provided, in response to the user's registration to the event, such as by purchasing an event admission ticket, with the stream access code required to connect to the related broadcast audio stream, with the personal device 60 thereafter wirelessly transmitting the stream access code to the hearing devices so that they can connect to the audio stream 74.

According to one example, the personal device 60 may be provided with the stream access code via a public communication network, such as the internet or a telephone network. In particular, the personal device 60 may be provided with a stream access code via a standard text message, such as an SMS or an email, or via an internet download.

According to another example, the personal device 60 may be provided with the stream access code via a wireless link, such as a BLUETOOTH® link, a WiFi link or an NFC (“near field communication”) link, established between the personal device 60 and an event registration location, such as a ticket booth, of the provider of the audio stream 74.

According to another example, the personal device 60 may comprise a camera, and the stream access code may be provided by scanning, using the camera, an optical code pattern, such as a bar code or a QR code, provided by the provider of the audio stream 74. For example, the optical code pattern may be printed on a ticket obtained by the user upon registration for the event, e.g. when purchasing the ticket.

FIG. 2 is an illustration of an example, wherein the stream access code is provided to the personal device 60, which may be a mobile phone, via a communication network 80, such the internet or a telephone network, from e.g. a movie theatre web portal 82 upon purchasing an online cinema ticket. To this end, the personal device 60 is connected to the cinema web portal 82 via the network 80 and receives, upon purchasing a ticket, the ticket itself and a stream access code required for accessing an audio stream 74 in the movie theatre.

According to the next step, which is illustrated in FIG. 3, the personal device 60 transmits the received stream access code via the wireless link 72 to the hearing devices 10, 11.

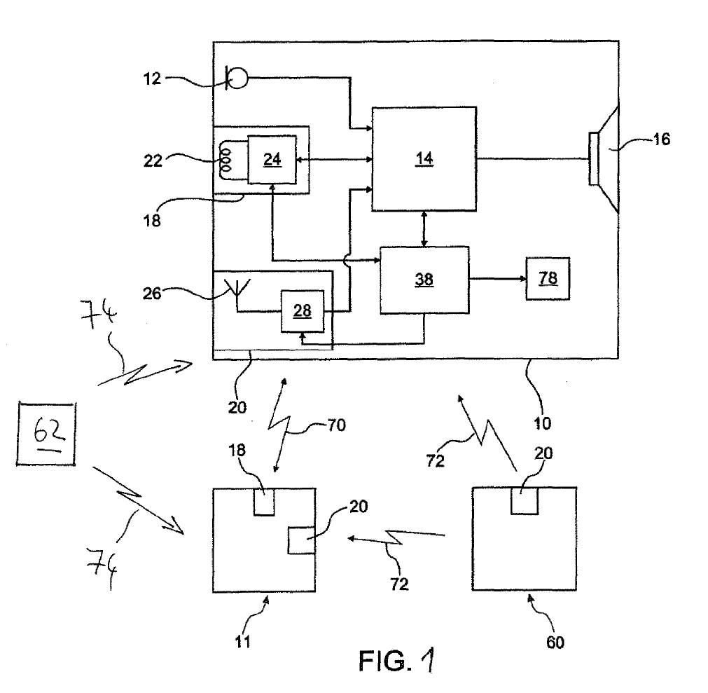

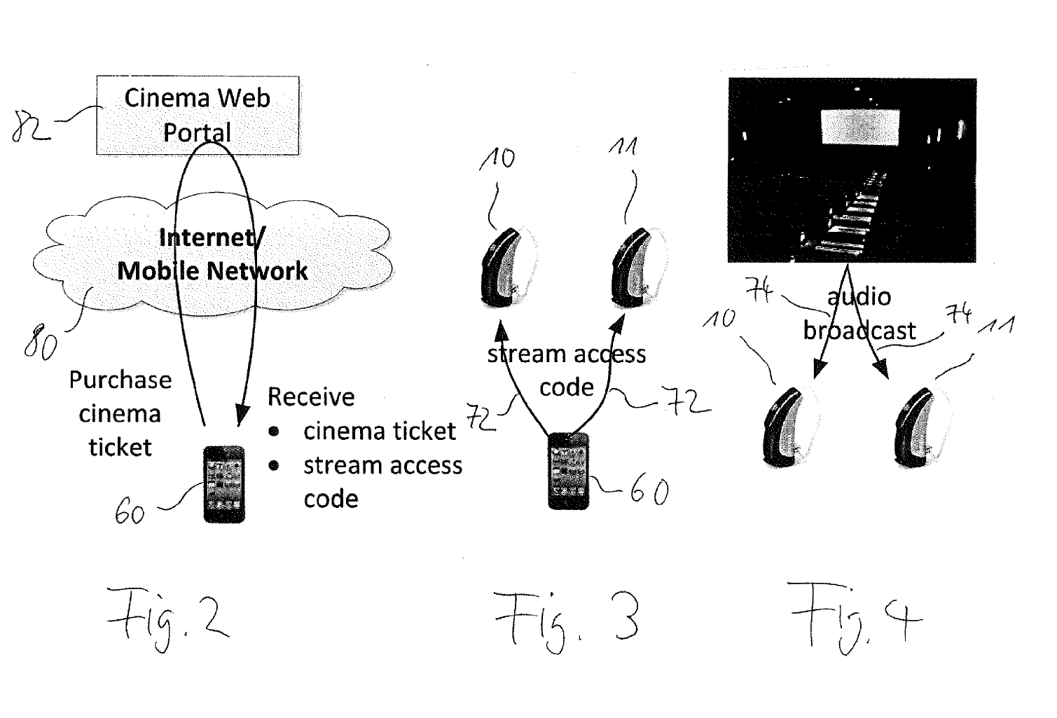

Thereafter, as illustrated in FIG. 4, the hearing devices 10, 11 may connect to the audio stream 74 in the movie theatre.

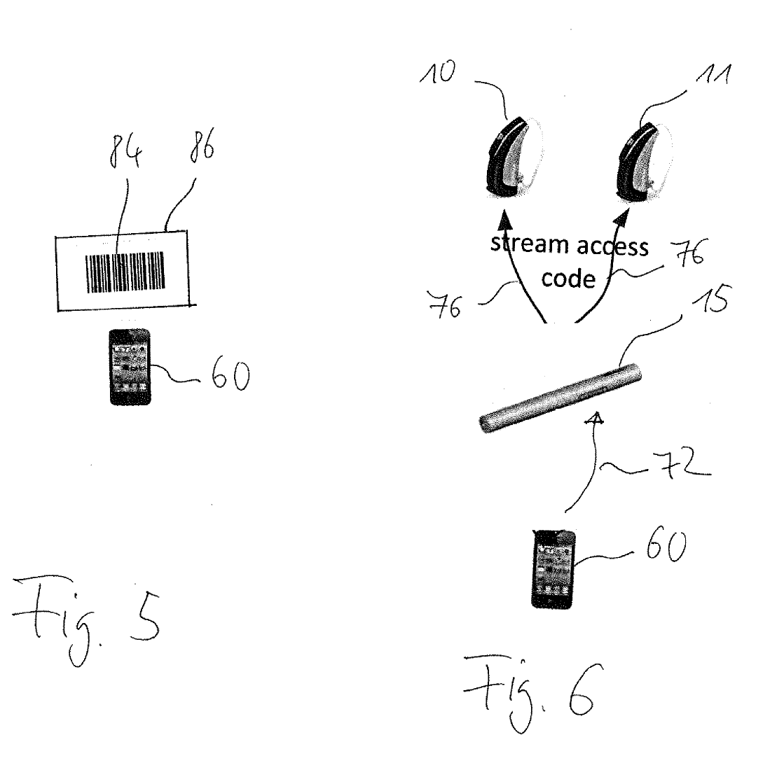

A variant of the first step of obtaining the stream access code by the personal device 60 is illustrated in FIG. 5, according to which the personal device 60 scans an optical code 84 printed on a ticket 86 in order to obtain the stream access code by decoding the optical code.

A variant to the second step of providing the stream access code from the personal device 60 to the hearing devices 10, 11 is illustrated in FIG. 6, wherein a relay device 15 is provided as part of the hearing assistance system. The relay device communicates with the hearing devices 10, 11 via a wireless link 76 and with the personal device 60 via the wireless link 72 (in principle, the link between the relay device 15 and the hearing device 10, 11 may use the same protocol as the link 72 between the personal device 60 and the relay device 15, or it may use a different protocol and technology; for example, it may be a proprietary link).

In the example of FIG. 6, the stream access code is transmitted from the personal device 60 to the relay device 15 via the wireless link 72, and then the stream access code is transmitted from the relay device 15 via the wireless link 76 to the hearing devices 10, 11. The relay device 15 may act, for example, as a wireless microphone and/or as an audio streaming device for streaming an external audio stream, for example, the audio signals received by the personal device during a phone call, to the hearing devices 10, 11.

Rather than providing the stream access code to both hearing devices 10, 11, the stream access code may be provided only to one of the hearing devices, for example the hearing device 10, with that hearing device then forwarding the stream access code via the binaural link 70 to the other hearing device 11. This variant applies both to embodiments with or without a relay device 15 being used for providing the stream access code.

As already mentioned above, in some cases the user of the hearing devices may wish to access an audio stream which is not related to a certain event for which the user may register. For example, an audio stream may be provided in a room with free public access, such as a train station, airport building or a room for religious services. Another application would be a class room for teaching of hearing impaired persons via wireless microphones used by the teachers. In any such cases, the stream access code may be provided as an optical pattern in the room, for example as a print-out or panel at the entrance of the room (typically, the optical code pattern may be provided within the range of the audio stream). The personal device 60 of the user then would be utilized for scanning the optical pattern in order to decode it for obtaining the stream access code. The stream access code then may be transmitted directly to at least one of the hearing aids, or it may be transmitted first to a relay device 15 and from there to at least one of the hearing devices.

For obtaining the stream access code from the optical code pattern, the personal device 60 may be provided with a corresponding “app” which serves to scan the optical code pattern via a camera of the personal device 60 and to decode the optical code pattern then in order to obtain the stream access code.

In general, the stream access code may comprise a stream identifier which may be used to determine a data packet address and/or a frequency hopping sequence of the broadcast audio stream. The broadcast audio stream may be encrypted, with the stream access code then including a decryption key required to decrypt the broadcast audio stream.

The stream access code may also be encrypted (using private-key or public-key cryptography) to ensure that only the intended recipient can decrypt and exploit it.

According to one example, the stream access code may be changed upon expiry of a time limit in order to impose a time limit on the stream access. In such cases, the stream access code may be erased from the memory of the hearing system after expiry of the time limit.

According to another example, which does not form part of the invention, the hearing devices may be provided directly with the stream access code (i.e., without the help of a personal device) after the user of the hearing device has registered to an event. For example, a computer at the ticket booth where a ticket was purchased by the user may establish, via an appropriate interface, a wireless link to the hearing devices in order to provide the hearing devices with the stream access code of an audio stream related to the event for which the user has registered.

What is claimed is:

1. A method of providing hearing assistance to a user of a hearing system (10, 11, 15) by utilizing an event-related audio broadcast stream (74), the method comprising:
registering, by the user, for an event;
providing, in response to said registering, a personal device (60) of the user with a stream access code required to connect to the broadcast audio stream;
establishing a wireless link (72) between the hearing system and the personal device and transmitting the stream access code from the personal device to the hearing system; and
connecting, by the hearing system, to the broadcast audio stream.

2. The method of claim 1, wherein the personal device (60) is provided with the stream access code via a public communication network. (80)

3. The method of claim 1, wherein the personal device (60) is provided with the stream access code via a standard text message, such as an SMS or an email, or via an internet download.

4. The method of claim 1, wherein the personal device (60) is provided with the stream access code via a wireless link, such as Bluetooth link, a WiFi link, or an NFC link, established between the personal device and an event registration location of the provider of the broadcast audio stream.

5. The method of claim 1, wherein the personal device (60) comprises a camera, with the stream access code being provided by scanning, using the camera, an optical code pattern (84), such as a bar code or a QR code, provided by the provider of the broadcast audio stream.

6. The method of claim 5, wherein the optical code pattern (84) is printed on a ticket (86) obtained by the user upon registration for the event.

7. The method of claim 1, wherein the event registration comprises purchasing an event admission ticket (86).

8. A method of providing hearing assistance to a user of a hearing system (10, 11, 15) by utilizing an audio broadcast stream (74), the method comprising:
providing an optical code pattern (84) encoding a stream access code required to connect to the broadcast audio stream,
scanning, by a personal device (60) of the user, the optical code pattern and decoding the optical code pattern in order to obtain the stream access code;
establishing a wireless link (72) between the hearing system and the personal device and transmitting the stream access code from the personal device to the hearing system; and
connecting, by the hearing system, to the broadcast audio stream.

9. The method of claim 8, wherein the optical code pattern (84) is provided at a location within the range of the broadcast audio stream (74).

10. The method of claim 9, wherein the optical code pattern (84) is provided at an entrance to a room within the range of the broadcast audio stream (74).

11. The method of claim 8, wherein the personal device (60) is a handheld or body-worn personal communication device, such as mobile phone or a tablet computer.

12. The method of claim 8, wherein the personal device is a personal computer.

13. The method of claim 8, wherein the wireless link (72) between the personal device (60) and the hearing system (10, 11, 15) uses BLUETOOTH®.

14. The method of claim 8, wherein the stream access code comprises a stream identifier.

15. The method of claim 14, wherein the stream identifier is used to determine a data packet address and/or a frequency hopping sequence of the broadcast audio stream.

16. The method of claim 8, wherein the broadcast audio stream (74) is encrypted, and wherein the stream access code includes a decryption key required to decrypt the broadcast audio stream.

17. The method of claim 16, wherein the stream access code is encrypted using private-key or public-key cryptography.

18. The method of claim 8, wherein the stream access code is changed upon expiry of a time limit in order to impose a time limit on the stream access.

19. The method of claim 18, wherein the stream access code is erased from the memory of the hearing system (10, 11, 15) after expiry of the time limit.

20. The method of claim 8, wherein the hearing system comprises at least one hearing device (10, 11) worn at ear level.

21. The method of claim 20, wherein the at least one hearing device (10, 11) is a hearing aid, hearing prosthesis or headphone.

22. The method of claim 21, wherein the hearing system includes a binaural system comprising a first hearing device (10) worn at one ear and a second hearing device (11) worn at the other ear.

23. The method of claim 20, wherein the hearing system comprises a relay device (15), wherein the stream access code is transmitted from the personal device (60) to the relay device via the wireless link (72), wherein the stream access code then is transmitted from the relay device to the at least one ear-level hearing device (10, 11) via another wireless link (76), and wherein the at least one ear-level hearing device connects to the broadcast audio stream (74).

24. The method of claim 22, wherein the stream access code is transmitted to the first hearing device (10), and wherein the first hearing device transmits the received stream access code to the second hearing device via a binaural wireless link (70) established between the first hearing device and the second hearing device (11) in order to enable the second hearing device to connect to the broadcast stream (74).

25. The method of claim 1, wherein the personal device is a personal computer.

26. The method of claim 1, wherein the wireless link (72) between the personal device (60) and the hearing system (10, 11, 15) uses BLUETOOTH®.
